(19) United States
(12) Patent Application Publication
(10) Pub. No.: US 2016/0379171 A1
(43) Pub. Date: Dec. 29, 2016

(54) CROWD-SOURCE CALENDAR SHARING

(71) Applicants: Alan D. Gatzke, Bainbridge Island, WA (US); Steven C. Prentice, Ephrata, WA (US); Steve W. Olivier, Seattle, WA (US)

(72) Inventors: Alan D. Gatzke, Bainbridge Island, WA (US); Steven C. Prentice, Ephrata, WA (US); Steve W. Olivier, Seattle, WA (US)

(73) Assignee: Cisco Technology, Inc., San Jose, CA (US)

(21) Appl. No.: 14/750,446

(22) Filed: Jun. 25, 2015

(51) Int. Cl. G06Q 10/10

(52) U.S. Cl. CPC G06Q 10/1095

(57) ABSTRACT

In one embodiment, a network interface receives a first calendar meeting report from a first user and a second calendar meeting report from a second user. The first user and the second user are located on an internal network. The first calendar meeting report comprises first meeting attendees and a first calendar meeting time. The second calendar meeting report comprises second meeting attendees and a second calendar meeting time. A processor determines a common meeting attendee from the first meeting attendees and the second meeting attendees. The common meeting attendee is located on an external network, and the first user and the second user are unable to access calendar scheduling data associated with the common meeting attendee. The processor then generates a common calendar on the internal network. The common calendar associated with the common meeting attendee comprises the first calendar meeting time and the second calendar meeting time.

### TECHNICAL FIELD

This disclosure relates generally to generating a common calendar, and more particularly to generating a common calendar from calendar meeting reports received from users on an internal network.

### BACKGROUND

Generally, users view the availability of proposed attendees in a calendar software to schedule a future calendar meeting with the proposed attendees. Users typically can view the availability of a proposed attendee only if the user can access the calendar scheduling data of the proposed attendee. Accordingly, a user may not be able to view the availability of a proposed attendee if the user cannot access the calendar scheduling data of the proposed attendee.

### BRIEF DESCRIPTION OF THE FIGURES

For a more complete understanding of the present disclosure and for further features and advantages thereof, reference is now made to the following description taken in conjunction with the accompanying drawings, in which:

FIG. 1 illustrates a system for generating a common calendar from calendar meeting reports received from users on an internal network;

FIG. 2 illustrates an example first calendar meeting report, which includes various information related to the first calendar meeting, and an example second calendar meeting report, which includes various information related to the second calendar meeting;

FIG. 3 illustrates an example common calendar, which includes calendar information for meeting attendants provided by the first calendar meeting report and the second calendar meeting report; and

FIG. 4 illustrates an example method for generating a common calendar from calendar meeting reports received from users on an internal network.

### DESCRIPTION OF EXAMPLE EMBODIMENTS

### Overview

According to embodiments of the present disclosure, disadvantages and problems associated with viewing the availability of a proposed attendee that exists on a network that does not share the proposed attendee's calendar scheduling data may be reduced or eliminated.

In accordance with a particular embodiment of the present disclosure, a network interface receives a first calendar meeting report from a first user and a second calendar meeting report from a second user. The first user and the second user are located on an internal network. The first calendar meeting report comprises first meeting attendees and a first calendar meeting time. The second calendar meeting report comprises second meeting attendees and a second calendar meeting time. A processor, communicatively coupled to the network interface, determines a common meeting attendee from the first meeting attendees and the second meeting attendees. The common meeting attendee is located on an external network, and the first user and the second user are unable to access calendar scheduling data associated with the common meeting attendee on the external network. The processor then generates a common calendar on the internal network. The common calendar associated with the common meeting attendee comprises the first calendar meeting time and the second calendar meeting time.

### Example Embodiments

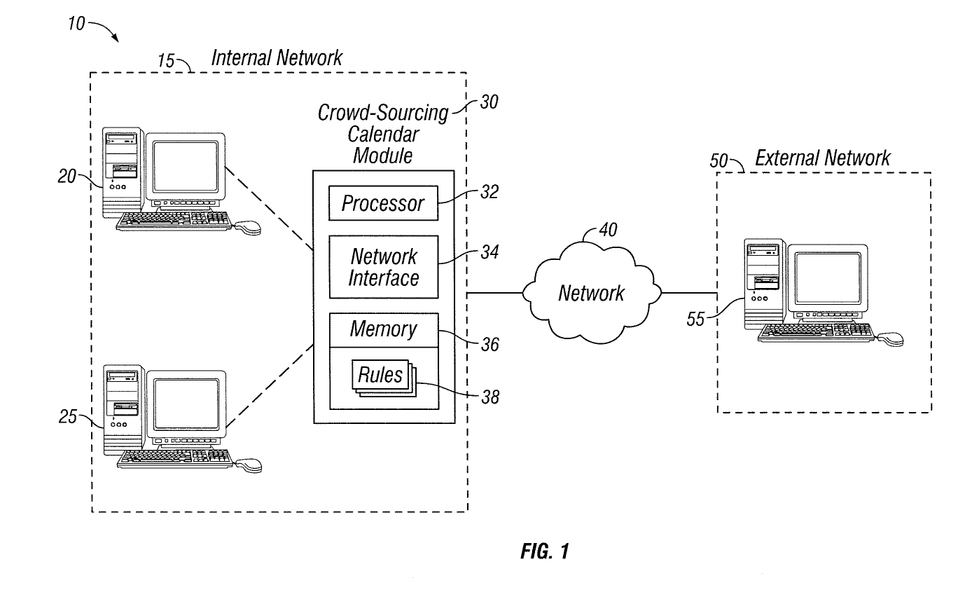

Embodiments of the present disclosure and its advantages are best understood by referring to FIGS. 1-4, like numerals being used for like and corresponding parts of the various drawings.

Generally, users view the availability of proposed attendees in a calendar software to schedule a future calendar meeting with the proposed attendees. Users typically can view the availability of a proposed attendee only if the user can access the calendar scheduling data of the proposed attendee. However, with the number of meetings conducted by users with employees of other organizations, it is becoming more common that users are scheduling meetings with individuals that users cannot access that individual's scheduling data. As such, a user may not be able to view the availability of that proposed attendee.

The teachings of this disclosure recognize that it would be desirable to provide a system that generates a common calendar for a user based on calendaring information that exists on an internal network, especially when that user's calendar scheduling data is not accessible. The teachings of this disclosure also recognize that it would be desirable to respond to a query requesting common calendar information for a specified user.

Certain embodiments of the present disclosure may provide one or more technical advantages. A technical advantage of one embodiment includes greater visibility of a proposed attendee's calendar schedule when scheduling a calendar meeting with that attendee, especially when the proposed attendee's scheduling data cannot be accessed. Another technical advantage of one embodiment includes improving the usability of the calendar scheduling feature used in many calendaring software programs. As yet another example, a technical advantage of one embodiment includes greater efficiencies in network resources by limiting the amount of calendar scheduling data shared across networks. As yet another example, a technical advantage of one embodiment includes achieving greater efficiencies in computer resources as the generated calendar may exist on a computer separate from the user's computer. As yet another example, a technical advance of one embodiment is improving the visibility of a user's scheduled calendar meetings when the user's scheduling data cannot be accessed.

Other technical advantages of the present disclosure will be readily apparent to one skilled in the art from the following figures, descriptions, and claims. Moreover, while specific advantages have been enumerated above, various embodiments may include all, some, or none of the enumerated advantages.

FIG. 1 illustrates a system for generating a common calendar from calendar meeting reports received from users on internal network 15. More specifically, system 10 includes internal network 15, network 40, and external network 50. Internal network 15 includes first user 20, second user 25, and crowd-sourcing calendar module 30. Crowd-sourcing calendar module 30 includes processor 32, network interface 34, and memory 36; memory 36 further includes rules 38. External network 50 includes external user 55.

System 10 includes internal network 15. Internal network 15 facilities communicating and receiving information, such as calendar scheduling data, calendar information, and a common calendar, from first user 20, second user 25, crowd-sourcing calendar module 30, and other components of system 10. Calendaring scheduling data represents data that contains information about a user's calendar. Typically, calendar scheduling data is stored on a module for access by meeting coordinators when scheduling a calendar meeting with the particular user. As an example, first user 20 in internal network 15 may view the scheduling information (e.g., available or busy) regarding second user 25 in internal network 15 because first user 20 can access the calendar scheduling data of second user 25.

Although FIG. 1 depicts first user 20, second user 25, and crowd-sourcing calendar module 30 existing on a single network, the disclosure contemplates internal network 15 comprising multiple networks, such as networks belonging to different enterprises. These multiple networks form internal network 15 by sharing its users' calendar information across the multiple networks. Accordingly, a user in Enterprise A may be able to see the availability of a user in Enterprise B if Enterprise A and Enterprise B previously established a trust relationship to share its users' calendaring information across the networks.

This disclosure contemplates any suitable internal network 15 operable to facilitate communication of calendaring information between the components of system 10. Internal network 15 may include any interconnecting system capable of transmitting audio, video, signals, data, messages, or any combination of the preceding. Internal network 15 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components. This disclosure contemplates end networks having one or more of the described properties of internal network 15.

First user 20 may be any user that schedules and/or stores calendar information on a calendaring software. Example calendaring software includes MICROSOFT OUTLOOK, MOZILLA THUNDERBIRD, LOTUSNOTES, GOOGLE CALENDAR, or any other software application that can track appointments for a scheduled time on a computer. First user 20 may utilize a computer, workstation, telephone, Internet browser, graphical user interface (GUI), electronic notebook, Personal Digital Assistant (PDA), pager, mobile phone, or any other suitable device (wireless, wireline, or otherwise), component, or element capable of receiving, processing, storing, or communicating information with the calendaring software. In one embodiment, first user 20 communicates a first calendar meeting report to crowd-sourcing calendar module 30.

A first calendar meeting report comprises information garnered from a proposed calendar meeting request or a confirmed calendar meeting request. Typically, first user 20 is the meeting organizer for the first calendar meeting. The first calendar meeting is necessarily rooted in computer technology. The first calendar meeting report may comprise one or more first meeting attendees and a first calendar meeting time. First meeting attendees consist of users that have accepted, declined, proposed a new meeting time, have not responded to a second calendared meeting, or any other type of interaction that can occur when responding to a meeting invite.

The first meeting attendees may comprise unique identifiers for the users invited and/or attending the calendar meeting. Example identifiers include user names associated with the individuals, e-mail addresses, or any other indicator that identifies the user and/or users in the first meeting attendees. In certain embodiments, the first meeting attendee may correspond to a group of individuals.

The first calendar meeting report may also comprise information related to an action or inaction of the first meeting attendees to the first calendar meeting. For example, the first calendar meeting report may associate a first meeting attendee with accepting the first calendar meeting at the first calendar meeting time, declining the first calendar meeting at the first calendar meeting time, proposing a new time to the first calendar meeting (while also keeping track of the proposed original time), not responding to the first calendar meeting request, or any other action or inaction that a user may be associated with for a first calendar meeting. In certain embodiments, the first calendar meeting report may contain information pertaining to an out-of-office message indicating that a particular user or group of users may be out of the office for a specific period of time. In addition, the first calendar meeting report may contain any information associated with the meeting, such as the location of meeting and the subject of the meeting.

The first calendar meeting time comprises the meeting time associated with the first calendar meeting. An example meeting time may be 11:00 A.M. to 11:30 P.M. (Eastern Daylight Time) on May 20, 2015. A meeting time may consist of one meeting time, multiple meeting times, or periodic meeting times. In certain embodiments, first calendar meeting time may associate different actions of a first meeting attendee across a meeting time. For example, for a meeting that occurs between 10:00 A.M. to 11:00 AM, a particular user may accept the meeting from 10:00 A.M. to 10:30 AM, but may decline the same meeting from 10:30 A.M. to 11:00 AM.

The first calendar meeting report may be pushed to crowd-sourcing calendar module 30 when a change occurs in the first user's calendar, occurs manually from an interaction from first user 20, or occurs periodically on a set time basis. In an alternate embodiment, the accept, decline, and/or proposed new time responses received by the meeting organizer and/or meeting participants are automatically pushed or sent to crowd-sourcing calendar module 30. Furthermore, software may exist separately or is embedded in calendaring software that may determine changes in the calendaring software in first user 20.

Similar to first user 20, second user 25 may be any user that schedules and/or stores calendar information on a calendaring software. Example calendaring software includes MICROSOFT OUTLOOK, MOZILLA THUNDERBIRD, LOTUSNOTES, GOOGLE CALENDAR, or any other software application that can track appointments for a scheduled time on a computer. Second user 25 may utilize a computer, workstation, telephone, Internet browser, GUI, electronic notebook, PDA, pager, mobile phone, or any other suitable device (wireless, wireline, or otherwise), component, or element capable of receiving, processing, storing, or communicating information with the calendaring software. In one embodiment, second user 25 communicates a second calendar meeting report to crowd-sourcing calendar module 30.

A second calendar meeting report comprises information garnered from a proposed calendar meeting request or a confirmed calendar meeting request. Typically, second user 25 is the meeting organizer for the second calendar meeting. The second calendar meeting report is necessarily rooted in computer technology. The second calendar meeting report may comprise one or more second meeting attendees and a second calendar meeting time. Second meeting attendees consist of users that have accepted, declined, proposed a new meeting time, have not responded to a second calendared meeting, or any other type of interaction that can occur when responding to a meeting invite.

Like the first meeting attendees, the second meeting attendees may comprise unique identifiers for the users invited and/or attending the calendar meeting. Example identifiers include user names associated with the individuals, e-mail addresses, or any other indicator that identifies the user and/or users in the first meeting attendees. In certain embodiments, the second meeting attendee may correspond to a group of individuals.

The second calendar meeting report may also comprise information related to an action or inaction of the second meeting attendees to the second calendar meeting. For example, the second calendar meeting report may associate a second meeting attendee with accepting the second calendar meeting at the second calendar meeting time, declining the second calendar meeting at the second calendar meeting time, proposing a new time to the second calendar meeting (while also keeping track of the proposed original time), not responding to the second calendar meeting, or any other action or inaction that a user may be associated with for a second calendar meeting. In certain embodiments, the second calendar meeting report may contain information pertaining to an out-of-office message indicating that a particular user or group of users may be out of the office for a specific period of time. In addition, the second calendar meeting report may contain any information associated with the meeting, such as the location of meeting and the subject of the meeting.

The second calendar meeting time comprises the meeting time associated with the first calendar meeting. An example meeting time may be 11:00 A.M. to 11:30 P.M. (Eastern Daylight Time) on May 20, 2015. A meeting time may consist of one meeting time, multiple meeting times, or periodic meeting times. In certain embodiments, second calendar meeting time may associate different actions of a second meeting attendee across a meeting time. For example, for a meeting that occurs between 10:00 A.M. to 11:00 AM, a particular user may accept the meeting from 10:00 A.M. to 10:30 AM, but may decline the same meeting from 10:30 A.M. to 11:00 AM.

The second calendar meeting report may be pushed to crowd-sourcing calendar module 30 when a change occurs in the second user's calendar, occurs manually from an interaction from second user 25, or occurs periodically on a set time basis. In an alternate embodiment, the accept, decline, and/or proposed new time responses received by the meeting organizer and/or meeting participants are automatically pushed or sent to crowd-sourcing calendar module 30. Furthermore, software may exist separately or is embedded in calendaring software that may determine changes in the calendaring software in second user 25.

In certain embodiments, second user 25 may be the same user as first user 20 but on different calendaring software programs or different accounts. For example, first user 20 may be the user's work calendaring software program, whereas second user 25 may be the user's home calendaring software program. In certain embodiments, crowd-sourcing calendar module 30 identifies that the similar user has multiple accounts and treats the multiple accounts as a single user.

Crowd-sourcing calendar module 30 represents any suitable components that facilitate receiving calendar meeting reports from various users, determining common meeting attendees from the received calendar meeting reports, generating a common calendar on internal network 15, and communicating the common calendar to permissible, requesting users. Crowd-sourcing calendar module 30 enables users within internal network 15 to view the availability of a user on external network 50 when the users on internal network 15 are unable to access calendar scheduling data for a user on external network 50. To facilitate this information, crowd-sourcing calendar module 30 receives a first calendar meeting report from first user 20, a second calendar meeting report from second user 25, determines a common meeting attendee from the meeting attendees associated with the received calendar meeting reports, and generates a common calendar on internal network 15. In certain embodiments, crowd-sourcing calendar module 30 receives a query concerning a common meeting attendee from a third user, verifies the third user has proper permissions to view the availability of the common meeting attendee, and communicates the common calendar to the third user.

Crowd-sourcing calendar module 30 may be located in internal network 15 or any other location that allows crowd-sourcing calendar module 30 to communicate with first user 20 and second user 25. Crowd-sourcing calendar module 30 may include a network server, any suitable remote server, a mainframe, a host computer, a workstation, a web server, a personal computer, a file server, or any other suitable device operable to communicate with first user 20 and second user 25. In some embodiments, crowd-sourcing calendar module 30 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of crowd-sourcing calendar module 30 may be performed by any suitable combination of one or more servers or other components at one or more locations. In the embodiment where the modules are servers, the servers may be public or private servers, and each server may be a virtual or physical server. The server may include one or more servers at the same or at remote locations. Also, crowd-sourcing calendar module 30 may include any suitable component that functions as a server.

Processor 32 controls the operation and administration of crowd-sourcing calendar module 30 by processing information received from network interface 34 and memory 36. Processor 32 communicatively couples to network interface 34 and memory 36. Processor 32 includes any hardware and/or software that operates to control and process information. For example, processor 32 utilizes rules 38 located in memory 36 to control the operation of crowd-sourcing calendar module 30. Processor 32 may be a programmable logic device, a microcontroller, a microprocessor, any suitable processing device, or any suitable combination of the preceding.

Network interface 34 represents any suitable device operable to receive information from internal network 15 and network 40, transmit information through internal network 15 and network 40, perform suitable processing of the information, communicate to other devices, or any combination of the preceding. For example, network interface 34 receives first calendar information and second calendar information from first user 20 and second user 25 respectively. As another example, network interface 34 receives a query from a third user and communicates a common calendar to the third user in response to the query. Network interface 34 represents any port or connection, real or virtual, including any suitable hardware and/or software, including protocol conversion and data processing capabilities, to communicate through a LAN, WAN, or other communication system that allows crowd-sourcing calendar module 30 to exchange information with first user 20, second user 25, a third user, external user 55, and other components of system 10.

Memory 36 represents a database that stores, either permanently or temporarily, received data reports from prior information calls. Memory 36 includes any one or a combination of volatile or non-volatile local or remote devices suitable for storing information. For example, memory 36 may include RAM, ROM, magnetic storage devices, optical storage devices, or any other suitable information storage device or a combination of these devices. Memory 36 may include any suitable information for use in the operation of crowd-sourcing calendar module 30. In certain embodiments, memory 36 stores a security profile for each individual. The security profile details permission rights for each user, including whether that user can access the common calendar for a particular user or particular set of users. Additionally, memory 36 may be a component external to crowd-sourcing calendar module 30. Memory 36 can be located in internal network 15 or any other location suitable for memory 36 to communicate with crowd-sourcing calendar module 30

Rules 38 represent logic, rules, algorithms, code, tables, and/or other suitable instructions in a computer-readable storage medium for identifying common meeting attendees in received calendar information, determining permission rights for a third user that communicated a query, and tracking publication request information for users in the common calendar.

Network 40 facilitates communications between components in internal network 15 (such as first user 20, second user 25, and crowd-sourcing calendar module 30) and components in external network 50 (such as external user 55). This disclosure contemplates any suitable network 40 operable to facilitate communication between the components of system 10. Network 40 may include any interconnecting system capable of transmitting audio, video, signals, data, messages, or any combination of the preceding. Network 40 may include all or a portion of a PSTN, a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components. This disclosure contemplates end networks having one or more of the described properties of network 40.

External network 50 may include any interconnecting system capable of transmitting audio, video, signals, data, messages, or any combination of the preceding. External network 50 may include all or a portion of a PSTN, a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the components. This disclosure contemplates end networks having one or more of the described properties of external network 50.

Notably, in some embodiments, first user 20 and/or second user 25 cannot access calendar scheduling data for users in external network 50. For instance, internal network 15 and external network 50 may not have established a trust relationship such that first user 20 and second user 25 cannot access the calendar scheduling data of external user 55. As another example, external user 55 may have calendar permissions established such that the external user's calendar scheduling data is not shared. Similar to the previous example, first user 20 and second user 25 are then unable to access calendar scheduling data associated with external user 55.

External user 55 may be any user that schedules and/or stores calendar information on a calendaring software. Example calendaring software includes MICROSOFT OUTLOOK, MOZILLA THUNDERBIRD, LOTUSNOTES, GOOGLE CALENDAR, or any other software application that can track appointments for a scheduled time on a computer. External user 55 may utilize a computer, workstation, telephone, Internet browser, GUI, electronic notebook, PDA, pager, mobile phone, or any other suitable device (wireless, wireline, or otherwise), component, or element capable of receiving, processing, storing, or communicating information with the calendaring software. In an example embodiment, first user 20 and second user 25 cannot access calendar scheduling data for external user 55. External user 55 may modify its calendaring scheduling data by use the calendaring software located on his or her computer.

In certain embodiments, external user 55 is the common meeting attendee from the first calendar meeting report from first user 20 and the second calendar meeting report from second user 25. As an example, external user 55 may accept a first calendar meeting from first user 20 and decline a different calendar meeting from second user 25. Crowd-sourcing calendar module 30 may determine external user 55 as the common meeting attendee by identifying external user 55 in both the first calendar meeting report and the second calendar meeting report. In particular, crowd-sourcing calendar module 30 may associate external user 55 with accepting the first meeting and declining the second meeting.

In an exemplary embodiment of operation, first user 20 communicates a first calendar meeting report to crowd-sourcing calendar module 30. The communication may be pushed to crowd-sourcing calendar module 30 when a change occurs in the first user's calendar, occurs manually from an interaction from the first user, or occurs periodically on a set time basis. In an alternate embodiment, the acceptance, decline, and/or proposed new time responses received by the meeting organizer are automatically pushed or sent to crowd-sourcing calendar module 30. In another embodiment, software may exist on the first user's computer to determine changes in the first user's calendaring software.

The first calendar meeting report may comprise one or more first meeting attendees and a first calendar meeting time. First meeting attendees consist of users that have accepted, declined, proposed a new meeting time, have not responded to a second calendared meeting, or any other type of interaction that can occur when responding to a meeting invite.

The first meeting attendees may comprise unique identifiers for the users invited and/or attending the calendar meeting. Example identifiers include user names associated with the individuals, e-mail addresses, or any other indicator that identifies the user and/or users in the first meeting attendees. In certain embodiments, the first meeting attendee may correspond to a group of individuals. The first calendar meeting report may also comprise information related to an action or inaction of the first meeting attendees to the first calendar meeting. For example, the first calendar meeting report may associate a first meeting attendee with accepting the first calendar meeting at the first calendar meeting time, declining the first calendar meeting at the first calendar meeting time, proposing a new time to the first calendar meeting (while also keeping track of the proposed original time), not responding to the first calendar meeting, or any other action or inaction that a user may be associated with for a first calendar meeting. In certain embodiments, the first calendar meeting report may contain information pertaining to an out-of-office message indicating that a particular user or group of users may be out of the office for a specific period of time. In addition, the first calendar meeting report may contain any information associated with the meeting, such as the location of meeting and the subject of the meeting.

Similarly, second user 25 communicates a second calendar meeting report to crowd-sourcing calendar module 30. Like first user 20, the communication may be pushed to crowd-sourcing calendar module 30 when a change occurs in the second user's calendar, occurs manually from an interaction from the first user, or occurs periodically on a set time basis. In an alternate embodiment, the acceptance, decline, and/or proposed new time responses received by the meeting organizer are automatically pushed or sent to crowd-sourcing calendar module 30. Software may exist on the second user's computer to determine changes in the second user's calendaring software. The second user's calendaring software may be different calendar software program than the calendaring software program of first user 20.

Similar to the first calendar meeting report, the second calendar meeting report may comprise one or more second meeting attendees and a second calendar meeting time. Second meeting attendees consist of users that have accepted, declined, proposed a new meeting time, have not responded to a second calendared meeting, or any other type of interaction that can occur when responding to a meeting invite.

The second meeting attendees may comprise unique identifiers for the users invited and/or attending the calendar meeting. Example identifiers include user names associated with the individuals, e-mail addresses, or any other indicator that identifies the user and/or users in the second meeting attendees. In certain embodiments, the second meeting attendee may correspond to a group of individuals. The second calendar meeting report may also comprise information related to an action or inaction of the second meeting attendees to the second calendar meeting. For example, the second calendar meeting report may associate a second meeting attendee with accepting the second calendar meeting at the second calendar meeting time, declining the second calendar meeting at the second calendar meeting time, proposing a new time to the second calendar meeting (while also keeping track of the proposed original time), not responding to the second calendar meeting, or any other action or inaction that a user may be associated with for a second calendar meeting. In certain embodiments, the second calendar meeting report may contain information pertaining to an out-of-office message indicating that a particular user or group of users may be out of the office for a specific period of time. In addition, the second calendar meeting report may contain any information associated with the meeting, such as the location of meeting and the subject of the meeting.

In this illustrated embodiment, both first user 20 and second user 25 are located on internal network 15. Internal network 15 may be any type of network or networks that communicate calendaring scheduling data across its network or networks. Calendaring scheduling data is data that contains information about a user's calendar. Typically, calendar scheduling data is stored on a module that allow users to access the module for calendar scheduling data when setting up a calendar meeting with another user. In such instances, a user in internal network 15 may see the scheduling information (i.e., available or busy) regarding another user in the internal network. In some scenarios, two individual networks owned by different enterprises may also share calendaring data by setting up a trust relationship between the two networks. These two networks form internal network 15 by sharing its users' calendar information regarding across these networks. Accordingly, a user in Enterprise A may be able to see the availability of a separate user in Enterprise B if the networks of Enterprise A and Enterprise B previously established a trust relationship to share its users' calendaring information across the networks.

However, a user in internal network 15 may not be able to see the scheduling information regarding another user outside of the internal network (e.g., external network 50). For instance, Enterprise A and Enterprise B may not have established a trust relationship wherein users share calendaring scheduling data across the networks of Enterprise A and Enterprise B. Here, the user in Enterprise A cannot view the availability of the user in Enterprise B because Enterprise A and Enterprise B are not in a trust relationship and, thus, do not share its users' calendar availability. As another example, a user may have permissions set in such a way that the user's calendaring scheduling data is not shared among other users. Similar to the previous example, a user in Enterprise A may not be able to see the calendar availability of a user in Enterprise B. Instead, the user in Enterprise A may need to coordinate with user in Enterprise B to schedule a meeting time, or the user in Enterprise A may notify the user in Enterprise B of a scheduled meeting with the user in Enterprise B subsequently accepting or denying that scheduled meeting.

Once crowd-sourcing calendar module 30 receives the first calendar meeting report from first user 20 and the second calendar meeting report from second user 25, crowd-sourcing calendar module 30 determines a common meeting attendee from the first meeting attendees associated with the first calendar meeting report and the second meeting attendees associated with the second meeting attendees. In certain embodiments, crowd-sourcing calendar module 30 compares the e-mail addresses of the first meeting attendees with the e-mail addresses of the second meeting attendees to find an e-mail address listed in both the first meeting attendees and the second meeting attendees. In an alternate embodiment, to efficiently compare meeting attendees, crowd-sourcing calendar module 30 may only compare meeting attendees that are located outside of the internal network (i.e., external network 50). In certain embodiments, crowd-sourcing calendar module 30 may exclude finding calendar information for certain attendees. For example, crowd-sourcing calendar module 30 may exclude a particular user, a group of users, e-mail addresses with a certain domain name, or other indicators that crowd-sourcing calendar module 30 may exclude when finding common meeting attendees and/or generating a common calendar. In an additional embodiment, crowd-sourcing calendar module 30 may find common meeting attendees for only specified users or a group of users. For example, crowd-sourcing calendar module 30 may find common meeting attendees for users that are part of a specified domain name.

In certain embodiments, crowd-sourcing calendar module 30 communicates a calendar information publication request to the common meeting attendees identified in the calendar meeting report. In alternate embodiments, crowd-sourcing calendar module 30 communicates a calendar information publication request to all the users identified by crowd-sourcing calendar module 30. The calendar information publication request allows the common meeting attendee to accept or deny the calendar information publication request. If denied, crowd-sourcing calendar module 30 may exclude the user's calendar information from the common calendar. If accepted, crowd-sourcing calendar module 30 may then use the user's calendar information to generate a common calendar.

Using the common attendee information, crowd-sourcing calendar module 30 may generate a common calendar on internal network 15. The common calendar may be accessible by first user 20, second user 25, or any other user or users that are granted access to the common calendar. In certain embodiments, users located on external network 50 may access the common calendar. The common calendar may also be cloud-based. By placing the common calendar on the cloud (i.e., hosting the common calendar on a hosted service over the Internet), software applications may access the common calendar using internet-enabled devices.

To generate the common calendar, crowd-sourcing calendar module 30 may determine all the users associated with the received calendar meeting reports. Notably, several of these calendar meeting reports may contain common users. For each user identified in the received calendar meeting report, crowd-sourcing calendar module 30 may determine the meetings the user indicated is attending, not attending, proposing a new time (and the originally-scheduled time for that meeting), and/or has not taken action during that meeting. Using those meetings and the associated calendar meeting time, crowd-sourcing calendar module 30 may generate a common calendar on internal network 15. In the common calendar, crowd-sourcing calendar module 30 associates a user (such as a common meeting attendee) with his or her calendar availability during the associated calendar meeting times. The calendar availability indicates whether the user accepted a meeting, declined a meeting, proposed a new time, or any other type of action or inaction in response to a proposed calendar meeting. As such, crowd-sourcing calendar module 30 develops a common calendar that contains the calendar availability and calendar meeting time for each user in the received calendar meeting reports. Notably, a common calendar may be generated for external user 55 even when the calendar scheduling data of external user 55 is inaccessible by users located in internal network 15.

In certain embodiments, crowd-sourcing calendar module 30 may receive additional calendar meeting reports from first user 20 and/or second user 25. Crowd-sourcing calendar module 30 may then determine if the meeting attendees in the new calendar meeting reports match a common meeting attendee previously identified in the common calendar. If so, crowd-sourcing calendar module 30 may associate the newly-received calendar meeting report with the common meeting attendee. For example, first user 20 may communicate a declined calendar meeting response to crowd-sourcing calendar module 30. Crowd-sourcing calendar module 30 may then determine whether the declined meeting attendee matches the common meeting attendee previously identified in the common calendar. If the declined meeting attendee matches the previously-identified common meeting attendee, crowd-sourcing module 30 may then update the common calendar associated with the common meeting attendee to include the declined meeting time and that the common meeting attendee declined a meeting during that time. As another example, first user 20 may communicate a proposed new time response, wherein the proposed new time calendar meeting response comprises a proposer, an original meeting time, and a proposed new meeting time. Crowd-sourcing calendar module 30 may then determine whether the proposer matches a previously-identified common meeting attendee. If the proposer matches a previously-identified common meeting attendee, crowd-sourcing calendar module 30 may then update the common calendar associated with the common meeting attendee to include the original meeting time, the proposed new meeting time, and also identify that the common meeting attendee proposed a new time from the original meeting time.

Crowd-sourcing calendar module 30 may also receive a request from a third user requesting calendar information pertaining to a particular user or group of users. In certain embodiments, the request may also comprise a specific time frame of interest. The third user may be any user or individual in internal network 15 or external network 50 inquiring about a particular user or group of users. After receiving the query, crowd-sourcing calendar module 30 determines whether the third user has permission to access information associated with the requested user. In certain embodiments, crowd-sourcing calendar module 30 contains a list of permissions associated with each user. The permissions may indicate whether a requesting user has access to the common calendar or, in particular embodiments, the requesting user has permission to view calendaring information in the common calendar for specified users or specified groups of users.

If the third user has permission to access the common calendar for the requested user or group of users, crowd-sourcing calendar module 30 may return the calendar availability for the specified user in the request for the specified time frame. In certain embodiments, crowd-sourcing calendar module 30 provides all of the calendaring information for the specified user or group of users. In an alternative embodiment, crowd-sourcing calendar module 30 provides an interactive display for third user to view the calendaring times of the requested user or group of users. For example, crowd-sourcing calendar module 30 may provide a display for the third user using a web browser client. As another example, a user may use a software application to access the common calendar using an internet-enabled device.

A component of system 10 may include an interface, logic, memory, and other suitable elements. An interface receives input, sends output processes the input and/or output, and performs other suitable operations. An interface may comprise hardware and software. Logic performs the operation of the component. For example, logic executes instructions to generate output from input. Logic may include hardware, software and other logic. Logic may be encoded in one or more non-transitory, tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and other logic.

Modifications, additions, or omissions may be made to system 10 without departing from the scope of the disclosure. For example, system 10 may include any number of first users 20, second users 25, crowd-sourcing calendar modules 30, and external users 55. Furthermore, the components of system 10 may be integrated or separated. For example, first user 20 and crowd-sourcing calendar module 30 may be incorporated into a single component.

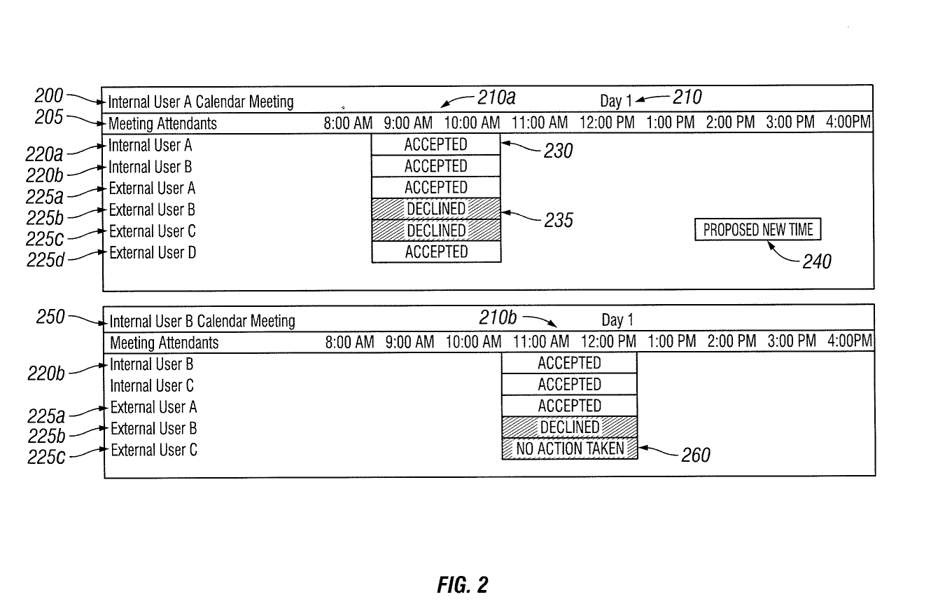

FIG. 2 illustrates an example first calendar meeting report 200, which includes various information related to first calendar meeting report 200, and an example second calendar meeting report 250, which includes various information related to second calendar meeting report 250. Although illustrated as a graphical display, first calendar meeting report 200 may be presented in a text file, a data structure, or any other means such that the information may be communicated across internal network 15. In the illustrated example, first calendar meeting report 200 represents a proposed calendar meeting by first user 20 (e.g., Internal User A in this example) on Day 1 between 9:00 A.M. and 11:00 A.M.

In the illustrated example, first calendar meeting report 200 includes meeting attendants field 205, meeting time field 210, internal meeting invitees 220, external meeting invitees 225, accepted notification 230, declined notification 235, and proposed new time notification 240.

Meeting attendants field 205 contains information regarding the proposed meeting attendants for the first calendar meeting report 200. In this example, Internal User A, Internal User B, External User A, External User B, External User C, and External User D comprise meeting attendants field 205. Each meeting attendant may accept a meeting request (such as accepted notification 230 by Internal User A), decline a meeting request (such as declined notification 235 by External User B), propose a new time for the meeting (such as proposed new time notification 240 by External User C), or ignore the meeting request (such as no action taken notification 260 by External User C in second calendar meeting report 250).

Meeting time field 210 comprises information regarding the meeting date regarding the first calendar meeting report and proposed new meeting time. In certain embodiments, meeting time field 210 comprises multiple meeting times to accommodate multiple meetings. In addition, meeting time field 210 may also include a meeting location and any other information related to the first calendar meeting. In the illustrated embodiment, meeting time field 210a for Internal User A corresponds to the meeting date and time for the first calendar meeting, and meeting time field 210b for Internal User B Calendar Meeting corresponds to the meeting date and time for the second calendar meeting.

Internal meeting invitees 220 consist of meeting attendants and meeting non-attendants that exist in internal network 15. For example, internal meeting invitees 220 in Internal User A Calendar Meeting includes Internal User A 220a and Internal user B 220b. Note that Internal User B 220b exists both in first calendar meeting report 200 and second calendar meeting report 250. In certain embodiments, first user 20 may view the availability of internal meeting invitees 220 because first user 20 can access the calendar scheduling data of internal meeting invitees 220.

External meeting invitees 225 consist of meeting attendants and meeting non-attendants that exist in external network 50. For example, external meeting invitees 225 in Internal User A Calendar Meeting includes External User A 225a, External User B 225b, External User C 225c, and External User D 225d. Note that External User A 225a, External User B 225b, and External User C 225c exists both in Internal User A Calendar Meeting and Internal User B Calendar Meeting. External meeting invitees 225 may be located on separate external networks 50. In certain embodiments, first user 20 cannot view the availability of external meeting invitees 225 because first user 20 cannot access the calendar scheduling data of external meeting invitees 225.

In addition, internal meeting invitees 220 and external meeting invitees 225 comprise unique identifiers for each internal meeting invitees 220 and external meeting invitees 225. Example identifiers include user names associated with the individuals, e-mail addresses, or any other indicator that identifies the user and/or users in the first meeting attendees. In certain embodiments, internal meeting invitees 220 and/or external meeting invitees 225 may correspond to a group of individuals.

Second calendar meeting report 250 is similar to first calendar meeting report 200. Second calendar meeting report 250 associates internal meeting attendees and external meeting attendees with the attendees' action towards the proposed meeting. Although illustrated as a graphical display, second calendar meeting report 250 may be presented in a text file, a data structure, or any other means such that the information may be communicated across internal network 15. In the illustrated example, second calendar meeting report 250 represents a proposed calendar meeting by second user 25 (e.g., Internal User B in this example) on Day 1 between 11:00 A.M. and 1:00 P.M.

Modifications, additions, or omissions may be made to first calendar meeting report 200 and second calendar meeting report 250 without departing from the scope of the disclosure.

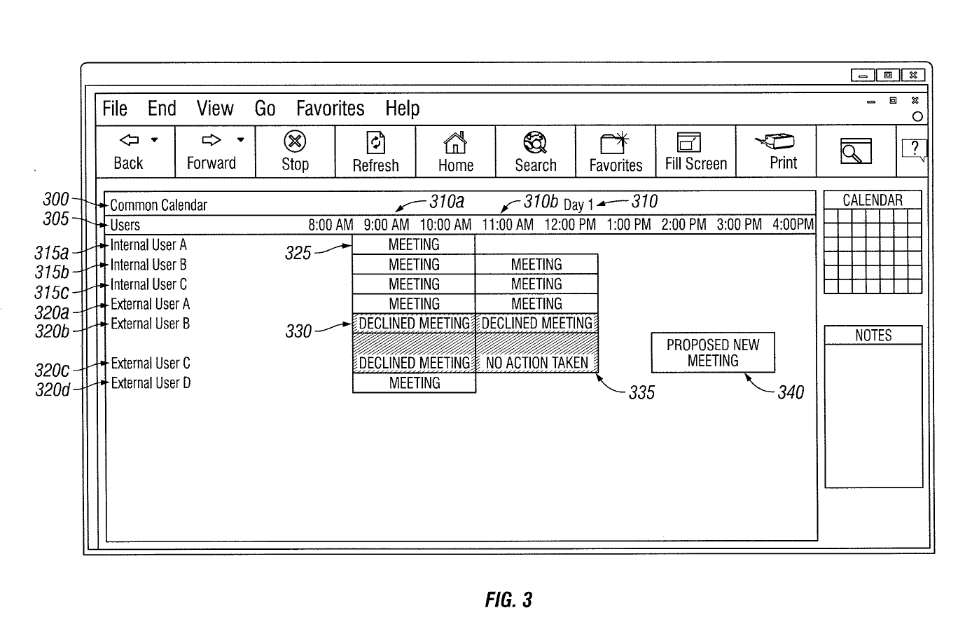

FIG. 3 illustrates an example common calendar 300, which includes calendar information for meeting attendants provided by first calendar meeting report 200 and second calendar meeting report 250. Although illustrated as a graphical display, first calendar meeting report 200 may be presented in a text file, a data structure, or any other means such that the information may be communicated across network 40. In the illustrated example, common calendar 300 represents a common calendar generated by crowd-sourcing calendar module 30 after receiving first calendar meeting report 200 from first user 20 and second calendar meeting report 250 from second user 25.

Users 305 represent all users that crowd-sourcing calendar module 30 contains an entry for in common calendar 300. As illustrated in common calendar 300, the list of users that stem from first user calendar meeting report 200 and second user calendar meeting report 250 include: Internal User A, Internal User B, Internal User C, External User A, External User B, External User C, and External User D. Crowd-sourcing calendar module 30 may continue to add an individual user to this list based on additional received calendar information.

Meeting time field 310 comprises information regarding the times of meetings associated with a user. First calendar meeting report 200 and second calendar meeting report 250 provides the information to place in meeting time field 310. Specifically, first user meeting time field 310a and second user meeting time field 310b corresponds to the meeting time in meeting time field 310a and time field 310b respectively in common calendar 300.

Internal user 315 corresponds to a group of internal users. In this illustrated embodiment, internal user 315 comprises Internal User A 315a, Internal User B 315b, and Internal User C 315c. In this example, crowd-sourcing calendar module 30 identifies Internal User A 315a as Internal User A 220a from first calendar meeting report 200 and also determines a common meeting attendee for Internal User A 315a does not exist in second calendar meeting report 250. Crowd-sourcing calendar module 30 also identifies that Internal User A 220a accepted a meeting on Day 1 from 9:00 A.M. to 11:00 A.M. Accordingly, crowd-sourcing calendar module 30 generates common calendar 300 to associate a meeting (identified by meeting notification 325) with Internal User A 315a on Day 1 from 9:00 A.M. to 11:00 A.M.

External user 320 corresponds to a group of internal users. In this illustrated embodiment, external user 320 comprises External User A 320a, External User B 320b, External User C 320c, and External User D 320d. In this example, crowd-sourcing calendar module 30 identifies External User A 320a as a common attendee: External User A 320a exists as External User A 225a in first calendar meeting report 200 and also exists in second calendar meeting report 250. Crowd-sourcing calendar module 30 further identifies that External User A 225a accepted a meeting in first calendar meeting report 200 on Day 1 from 9:00 A.M. to 11:00 A.M. and also accepted a meeting in second calendar meeting report 250 on Day 1 from 11:00 A.M. to 1:00 P.M. Accordingly crowd-sourcing calendar module 30 generates common calendar 300 to associate a meeting for External User A 320a (i.e., the common meeting attendee) on Day 1 from 9:00 A.M. to 11:00 A.M. based on the information gathered from received first calendar meeting report 200 and on Day 1 from 11:00 A.M. to 1:00 P.M. based on the information gathered from received second calendar meeting report 250.

In addition to tracking accepted meeting times, such as meeting notification 325, common calendar 300 may also track a declined meeting response (such as declined meeting notification 330), a lack of response to a meeting (such as no action taken notification 335) and a proposed new meeting time response (such as proposed new meeting notification 340).

Modifications, additions, or omissions may be made to common calendar 300 without departing from the scope of the disclosure.

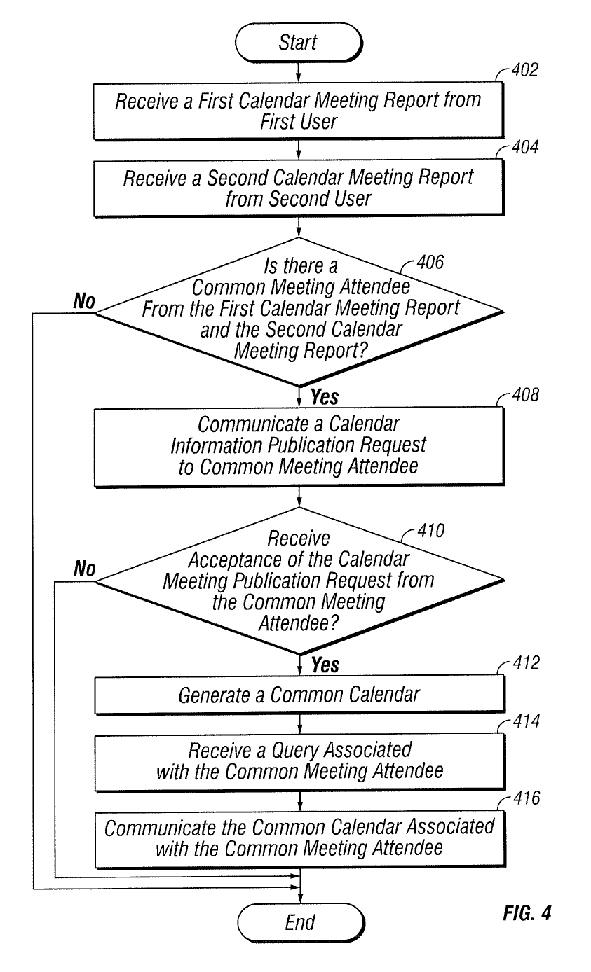

FIG. 4 illustrates an example method for generating a common calendar from calendar meeting reports received from users on internal network 15. At step 402, crowd-sourcing calendar module 30 receives first calendar meeting report 200 from first user 20. Similarly, at step 404, crowd-sourcing calendar module 30 receives a second calendar meeting report 250 from second user 25.

At step 406, crowd-sourcing calendar module 30 determines if there is a common meeting attendee from first calendar meeting report 200 and second calendar meeting report 250. If a common meeting attendee does not exist, the method ends. On the other hand, if there is a common meeting attendee in both first calendar meeting report 200 and second calendar meeting report 250, the method proceeds to step 408.

At step 408, crowd-sourcing calendar module 30 communicates a calendar information publication request to the identified common meeting attendee. The calendar information publication request allows the user to accept or deny the calendar information publication request. At step 410, the method determines if crowd-sourcing module 30 received an acceptance of the calendar meeting publication request from the common meeting attendee. If the common meeting attendee denies or fails to respond to the calendar information publication request, the method ends. If the common meeting attendee accepts the calendar information publication request, the method proceeds to step 412. In certain embodiments, crowd-sourcing calendar module 30 communicates the calendar information publication request again after a pre-determined period if the common meeting attendee does not respond to the initial calendar information publication request.

At step 412, crowd-sourcing calendar module 30 generates common calendar 300. To generate common calendar 300, crowd-sourcing calendar module 30 may determine the meetings the common meeting attendee indicated is attending, not attending, proposing a new time, the originally-scheduled time for that meeting, and/or has not taken action during that meeting. Using those meetings and the associated calendar meeting time, crowd-sourcing calendar module 30 may generate common calendar 300 for the common meeting attendee. In common calendar 300, crowd-sourcing calendar module 30 associates the common meeting attendee with his or her calendar availability during the associated calendar meeting times. The calendar availability indicates whether the common meeting attendee accepted a meeting, declined a meeting, proposed a new time, or any other type of action or inaction in response to a proposed calendar meeting.

Next, crowd-sourcing calendar module 30 may receive a query associated with the common meting attendee from a third user at step 414. In certain embodiments, the request may also comprise a specific time frame of interest. The third user may be any user or individual in internal network 15 or external network 50 inquiring about a particular user or group of users. After receiving the query, crowd-sourcing calendar module 30 may determine whether the third user has permission to access information associated with the requested user. In certain embodiments, crowd-sourcing calendar module 30 contains a list of permissions associated with each user. The permissions may indicate whether a requesting user has access to common calendar 300 or, in particular embodiments, the requesting user has permission to view calendaring information in common calendar 300 for specified users or specified groups of users.

If the third user has permission to access common calendar 300 for the requested user or group of users, crowd-sourcing calendar module 30 may communicate common calendar 300 associated with the common meeting attendee at step 416. Specifically, crowd-sourcing calendar module 30 may communicate the first calendar meeting time, the second calendar meeting time, and relating information regarding the first calendar meeting and the second calendar meeting to the third user. If the query also comprises a specific time frame of interest, crowd-sourcing calendar module 30 may communicate common calendar 300 associated with the common meeting attendee for the specified time frame. In certain embodiments, crowd-sourcing module provides all of the calendaring information for the specified user or group of users. In an alternative embodiment, crowd-sourcing calendar module 30 provides an interactive display for third user to view the calendaring times of the requested user or group of users.

Modifications, additions, or omissions may be made to the method depicted in FIG. 4. The method may include more, fewer, or other steps. For example, crowd-sourcing calendar module 30 may publish common calendar 300 to internal network 15, rather than receive a query from a third user regarding common calendar information for a specific user. As another example, crowd-sourcing calendar module 30 may host common calendar 300 such that users can access common calendar 300 via an internet-enabled device. As another example, steps may be performed in parallel, sequentially, or in any suitable order. While discussed as crowd-sourcing calendar module 30 performing the steps, any suitable component of system 10 may perform one or more steps of the method.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
a network interface operable to:
receive from a first user a first calendar meeting report, the first calendar meeting report comprising first meeting attendees and a first calendar meeting time, the first user located on an internal network; and
receive from a second user a second calendar meeting report, the second calendar meeting report comprising second meeting attendees and a second calendar meeting time, and the second user located on the internal network; and
a processor communicatively coupled to the network interface and operable to:
determine a common meeting attendee from the first meeting attendees and the second meeting attendees, the common meeting attendee located on an external network, and the first user and the second user are unable to access calendar scheduling data associated with the common meeting attendee on the external network; and
generate a common calendar on the internal network, the common calendar associated with the common meeting attendee comprising the first calendar meeting time and the second calendar meeting time.

2. The system of claim 1, wherein the network interface is further operable to:
receive a query from a third user, the query associated with the common meeting attendee; and
communicate the common calendar to the third user.

3. The system of claim 2, wherein the processor is further operable to:
access a security profile for the third user; and
determine whether the third user has permission to access information associated with the common meeting attendee.

4. The system of claim 1, wherein:
the first calendar meeting report further comprises a first calendar meeting location; and
the second calendar meeting report further comprises a second calendar meeting location.

5. The system of claim 1, wherein:
the network interface is further operable to receive from the first user a declined calendar meeting response, the declined calendar meeting response comprising a declined meeting attendee and a declined meeting time; and
the processor is further operable to:
determine whether the declined meeting attendee matches the common meeting attendee; and
when the declined meeting attendee matches the common meeting attendee, updating the common calendar associated with the common meeting attendee to include the declined meeting time.

6. The system of claim 1, wherein:
the network interface is further operable to receive from the first user a proposed new time calendar meeting response, the proposed new time calendar meeting response comprising a proposer, an original meeting time, and a proposed new meeting time; and
the processor is further operable to:
determine whether the proposer matches the common meeting attendee; and
when the proposer matches the common meeting attendee, updating the common calendar associated with the common meeting attendee to include the original meeting time and the proposed new meeting time.

7. The system of claim 1, wherein the network interface is further operable to:
communicate a calendar information publication request to the common meeting attendee; and
receive an acceptance of the calendar information publication request from the common meeting attendee.

8. A method, for:
receiving from a first user a first calendar meeting report, the first calendar meeting report comprising first meeting attendees and a first calendar meeting time, the first user located on an internal network;
receiving from a second user a second calendar meeting report, the second calendar meeting report comprising second meeting attendees and a second calendar meeting time, and the second user located on the internal network;
determining, by a processor, a common meeting attendee from the first meeting attendees and the second meeting attendees, the common meeting attendee located on an external network, and the first user and the second user are unable to access calendar scheduling data associated with the common meeting attendee on the external network; and
generating, by the processor, a common calendar on the internal network, the common calendar associated with the common meeting attendee comprising the first calendar meeting time and the second calendar meeting time.

9. The method of claim 8, further comprising:
receiving a query from a third user, the query associated with the common meeting attendee; and
communicating the common calendar to the third user.

10. The method of claim 9, further comprising:
accessing a security profile for the third user; and
determining whether the third user has permission to access information associated with the common meeting attendee.

11. The method of claim 8, wherein:
the first calendar meeting report further comprises a first calendar meeting location; and
the second calendar meeting report further comprises a second calendar meeting location.

12. The method of claim 8, further comprising:
receiving from the first user a declined calendar meeting response, the declined calendar meeting response comprising a declined meeting attendee and a declined meeting time;
determining, by the processor, whether the declined meeting attendee matches the common meeting attendee; and
when the declined meeting attendee matches the common meeting attendee, updating the common calendar associated with the common meeting attendee to include the declined meeting time.

13. The method of claim 8, further comprising:
receiving from the first user a proposed new time calendar meeting response, the proposed new time calendar meeting response comprising a proposer, an original meeting time, and a proposed new meeting time;
determining, by the processor, whether the proposer matches the common meeting attendee; and
when the proposer matches the common meeting attendee, updating the common calendar associated with the common meeting attendee to include the original meeting time and the proposed new meeting time.

14. The method of claim 8, further comprising:
communicating a calendar information publication request to the common meeting attendee; and
receiving an acceptance of the calendar information publication request from the common meeting attendee.

15. Non-transitory computer readable medium comprising logic, the logic, when executed by a processor, operable to:
receive from a first user a first calendar meeting report, the first calendar meeting report comprising first meeting attendees and a first calendar meeting time, the first user located on an internal network;
receive from a second user a second calendar meeting report, the second calendar meeting report comprising second meeting attendees and a second calendar meeting time, and the second user located on the internal network;
determine a common meeting attendee from the first meeting attendees and the second meeting attendees, the common meeting attendee located on an external network, and the first user and the second user are unable to access calendar scheduling data associated with the common meeting attendee on the external network; and
generate a common calendar on the internal network, the common calendar associated with the common meeting attendee comprising the first calendar meeting time and the second calendar meeting time.

16. The computer readable medium of claim 15, wherein the logic is further operable to:
receive a query from a third user, the query associated with the common meeting attendee; and
communicate the common calendar to the third user.

17. The computer readable medium of claim 16, wherein the logic is further operable to:
access a security profile for the third user; and
determine whether the third user has permission to access information associated with the common meeting attendee.

18. The computer readable medium of claim 15, wherein:
the first calendar meeting report further comprises a first calendar meeting location; and
the second calendar meeting report further comprises a second calendar meeting location.

19. The computer readable medium of claim 15, wherein the logic is further operable to:
receive from the first user a declined calendar meeting response, the declined calendar meeting response comprising a declined meeting attendee and a declined meeting time;
determine whether the declined meeting attendee matches the common meeting attendee; and
when the declined meeting attendee matches the common meeting attendee, update the common calendar associated with the common meeting attendee to include the declined meeting time.

20. The computer readable medium of claim 15, wherein the logic is further operable to:
receive from the first user a proposed new time calendar meeting response, the proposed new time calendar meeting response comprising a proposer, an original meeting time, and a proposed new meeting time;
determine whether the proposer matches the common meeting attendee; and
when the proposer matches the common meeting attendee, update the common calendar associated with the common meeting attendee to include the original meeting time and the proposed new meeting time.
